(19) United States
(12) Patent Application Publication
(10) Pub. No.: US 2011/0220342 A1
(43) Pub. Date: Sep. 15, 2011

(54) METHODS AND APPARATUS FOR SELECTIVELY REDUCING FLOW OF COOLANT IN A PROCESSING SYSTEM

(75) Inventor: Barry Page, San Jose, CA (US)

(73) Assignee: APPLIED MATERIALS, INC., Santa Clara, CA (US)

(21) Appl. No.: 13/034,906

(22) Filed: Feb. 25, 2011

Related U.S. Application Data
(60) Provisional application No. 61/313,353, filed on Mar. 12, 2010.

(51) Int. Cl. G05D 23/00; F28F 27/00

(52) U.S. Cl. 165/279; 165/200

(57) ABSTRACT

Methods and apparatus for selectively reducing the flow of a coolant are provided herein. In some embodiments, an apparatus for reducing the flow of a coolant may include a processing system comprising a process chamber; an abatement system coupled to the process chamber; a coolant source coupled to the process chamber and the abatement system for providing a coolant to the process chamber and the abatement system; and a controller configured to determine the readiness of the process chamber and the abatement system for operation in an idle mode and selectively reducing the flow of the coolant from the coolant source to one or both of the process chamber or the abatement system based on the readiness determination.

### CROSS-REFERENCE TO RELATED APPLICATIONS

This application claims benefit of U.S. provisional patent application Ser. No. 61/313,353, filed Mar. 12, 2010, which is herein incorporated by reference.

### FIELD

Embodiments of the present invention generally relate to methods and apparatus for cooling process equipment.

### BACKGROUND

Coolant is utilized in processing systems, for example, to cool a process chamber or its various components during operation. Further, coolant may be utilized to absorb effluents, solid particles or the like, for example, such as in the scrubber of an abatement system. Unfortunately, the inventor has discovered that coolant is often wasted due to continuing coolant flow independent of the operating state of the processing system, for example, such as when the chamber or abatement system is in an idle state.

Accordingly, the inventor has provided methods and apparatus to selectively reduce coolant flow based on the operating state of the processing system.

### SUMMARY

Methods and apparatus for selectively reducing the flow of a coolant are provided herein. In some embodiments, an apparatus for reducing the flow of a coolant includes a processing system comprising a process chamber; an abatement system coupled to the process chamber; a coolant source coupled to the process chamber and the abatement system for providing a coolant to the process chamber and the abatement system; and a controller configured to determine the readiness of the process chamber and the abatement system for operation in an idle mode and selectively reducing the flow of the coolant from the coolant source to one or both of the process chamber or the abatement system based on the readiness determination.

In some embodiments, the processing system further comprises a second process chamber coupled to the abatement system, wherein the coolant source is further coupled to the second process chamber for providing the coolant to the second process chamber and wherein the controller is further configured to determine the readiness of the second process chamber for operation in an idle mode and selectively reducing the flow of the coolant from the coolant source to the second process chamber based on the readiness determination.

In some embodiments, the processing system further comprises a second process chamber; and a second abatement system coupled to the second processing system, wherein the coolant source is further coupled to the second process chamber and the second abatement system for providing the coolant to the second process chamber and second abatement system, and wherein the controller is further configured to determine the readiness of the second process chamber and the second abatement system for operation in an idle mode and selectively reducing the flow of the coolant from the coolant source to one or both of the second process chamber or the second abatement system based on the readiness determination.

In some embodiments, a method for selectively reducing the flow of a coolant in a processing system includes monitoring a process chamber and an abatement system; determining operating states of the process chamber and the abatement system; and selectively reducing the flow of a coolant from a coolant source coupled to the processing system and the abatement system based on the determined operating states of the process chamber and the abatement system. In some embodiments, the flow of coolant from the coolant source to both the process chamber and the abatement system is a non-recirculating flow. Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a processing system in accordance with some embodiments of the present invention.

FIG. 2 depicts a processing system in accordance with some embodiments of the present invention.

FIG. 3 depicts a processing system in accordance with some embodiments of the present invention.

FIG. 4 depicts a flow chart for a method for selectively reducing the flow of a coolant in a processing system.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods and apparatus for selectively reducing the flow of a coolant are provided herein. The inventive methods and apparatus may advantageously reduce consumption of coolant in a processing system by selectively reducing the flow of coolant to one or more components of the processing system, such as a process chamber or abatement system, when each component is operating in an idle state or any other state having reduced coolant need.

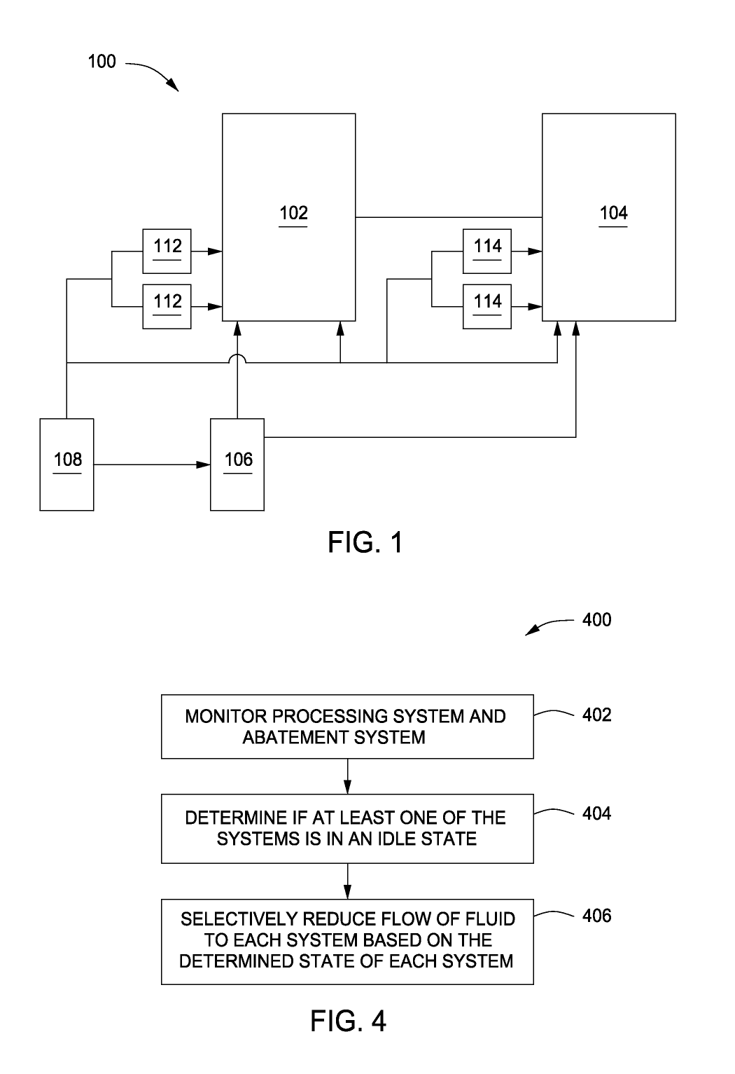

FIG. 1 depicts a processing system in accordance with some embodiments of the present invention. The processing system may be a standalone system as shown or part of a larger system, such as fabrication line (FAB) or the like. A processing system 100 includes a process chamber 102. An abatement system 104 may be coupled to the process chamber 102 for receiving effluents, byproducts, and the like resulting from one or more processes performed in the process chamber 102. A coolant source 106 may be coupled to the process chamber 102 and the abatement system 104 for providing a coolant to the process chamber 102 and the abatement system 104. The processing system 100 further includes a controller 108 which may be coupled to the process chamber 102, the abatement system 104, and the coolant source 106 for controlling the respective operations thereof. The controller 108 can be configured to determine the readiness of the process chamber 102 and/or the abatement system 104 for operation in an idle mode and may control the coolant source to selectively reduce the flow of the coolant from the coolant source 106 to one or both of the process chamber 102 or the abatement system 104 based upon the readiness determination. In some embodiments, the “readiness” of the process chamber or abatement system for operation in an idle mode can include instances where the process chamber and/or the abatement system are already in idle mode.

The process chamber 102 may include any suitable chamber for processing a substrate (not shown). Non-limiting examples of such process chambers include substrate processing systems used in, for example, semiconductor, flat panel, photovoltaic, or other silicon and thin film processing applications. For example, such process chambers may be configured for etching, oxidation, deposition, plasma processes, or other suitable processes utilized for any of the aforementioned processing applications.

For example, a substrate (not shown) that may be processed in the process chamber 102 may be any suitable material to be processed, such as a crystalline silicon (e.g., Si<100> or Si<111>), a silicon oxide, a strained silicon, a silicon germanium, a doped or undoped polysilicon, a doped or undoped silicon wafers, patterned or non-patterned wafers, silicon on insulator (SOI), carbon doped silicon oxides, silicon nitride, doped silicon, germanium, gallium arsenide, glass, sapphire, a display substrate (such as a liquid crystal display (LCD), a plasma display, an electro luminescence (EL) lamp display, or the like), a solar cell array substrate, a light emitting diode (LED) substrate, or the like. The substrate may have various dimensions, such as 200 mm or 300 mm diameter wafers, as well as rectangular or square panels. The frontside surface of the substrate may be hydrophilic, hydrophobic, or a combination thereof. The frontside surface may be patterned, or having one or more patterned layers, such as a photomask, disposed thereon.

The abatement system 104 can include any suitable abatement apparatus for processing and disposing of effluents, byproducts and like resulting from one or more processes performed in the process chamber 104. Although illustrated schematically in FIG. 1, the abatement system 104 may be coupled to the process chamber 102 at an exhaust port, such as configured for exhausting gaseous and/or at a drain, such as configured for exhausting liquid effluents. In addition, the abatement system 104 may be coupled to a plurality of process chambers. The abatement system 104 can include one or more of thermal combustion apparatus, thermal wet scrubbers, or the like. One exemplary, non-limiting example of suitable abatement systems are the Marathon and Marathon Solar abatement systems, available from Applied Materials, Inc. of Santa Clara, Calif.

The coolant source 106 can be any suitable coolant source that can selectively provide a coolant to either or both of the process chamber 102 and the abatement system 104 when operated by the controller 106. For example, the coolant source may further include one or more valves (not shown), where each valve can be coupled to a coolant line, such as those coolant lines running to the process chamber 102 and the abatement system 104, for selectively reducing the flow of coolant through the coolant line when at least partially closed by a signal from the controller 106. The coolant supplied by the coolant source can be any suitable coolant compatible with a process chamber or an abatement system, for example, the coolant can be any one or more of a heat transfer fluid, such as ethylene glycol or the like, an ultra low temperature coolant, such as liquid nitrogen or liquid helium, or further include additives to limit coolant breakdown. In some embodiments, the coolant is water.

In some embodiments, the coolant source is a non-recirculating coolant source (i.e., the coolant is not circulated from the coolant source 106 to the point of use and back to the coolant source 106 in a loop). For example, as shown in FIG. 1, coolant from the coolant source can be supplied to either or both of the process chamber 102 and the abatement system 104 to facilitate temperature control of the process chamber 102, the abatement system 104, or components thereof. The used coolant returning from the process chamber 102 and/or the abatement system 104 may be disposed of to the environment, collected for later treatment or disposal, or routed to an abatement system, such as the abatement system 104, for further treatment.

Alternatively, or in combination with the non-recirculating embodiments, the coolant source 106 (or another coolant source) can be recirculating. For example, in some embodiments, the coolant source 106 may be recirculating and may be utilized to cool process chamber or abatement system components, such as substrate support pedestals, thermal reactors, lamps or other suitable components that can be cooled by the coolant source without the coolant directly contacting, mixing, or becoming contaminated with process materials, such as process gases, effluents or materials removed from a substrate being processed. In such recirculating embodiments, the controller 108 may reduce the circulation rate of the coolant based on temperature measurement from the component to be cooled (e.g., by a temperature sensor) or, for example, based on power being supplied to the component, such as when no current is measured flowing through a heating lamp. Reducing the circulation rate may include changing the cycling rate, such as periodically cycling the coolant instead of continuously cycling the coolant.

Further, in some recirculating embodiments, the coolant source 106 may be a shared central system, such as a central heat exchange apparatus of a fabrication line (FAB). For example, the central heat exchange apparatus can provide the coolant, such as water, which can be utilized as a heat transfer fluid to remove heat from various components of the process chamber 102 and the abatement system 104.

Further, in some embodiments which include both non-recirculating and recirculating coolant, the coolant source 106 may be non-recirculating, for example, providing coolant to the process chamber 102 and abatement system 104 as illustrated in FIG. 1, but without the coolant being returned to the coolant source 106. However, the coolant, once provided to the process chamber 102 and abatement system 104 can be recirculated within the process chamber and/or abatement system multiple times prior to drainage or disposal. For example, the coolant provided by the coolant source 106 can be mixed with existing coolant which may be part of an internal chamber coolant system and recirculated in the internal chamber coolant system. The internal chamber coolant system may be utilized to cool various chamber components, and further may comprise one or more of a pump for recirculating the coolant, a coolant tank for receiving and storing coolant and recirculation loop for recirculating coolant to and from the coolant tank.

The controller 108 may comprise a central processing unit (CPU), a memory, and support circuits for the CPU (not shown). The controller 108 may control each component of the processing system 100 directly (as shown), or via computers (or controllers) associated with particular process chamber and/or the support system components. The controller 108 may be one of any form of general-purpose computer processor that can be used in an industrial setting for controlling various chambers and sub-processors. The memory, or computer-readable medium of the CPU may be one or more of readily available memory such as random access memory (RAM), read only memory (ROM), floppy disk, hard disk, flash, or any other form of digital storage, local or remote. The support circuits are coupled to the CPU for supporting the processor in a conventional manner. These circuits include cache, power supplies, clock circuits, input/output circuitry and subsystems, and the like. Inventive methods as described herein may be stored in the memory of the controller 108 as software routine that may be executed or invoked to control the operation of the processing system 100 in the manner described herein. The software routine may also be stored and/or executed by a second CPU (not shown) that is remotely located from the hardware being controlled by the controller 108.

The processing system may further include a first sensor 112 for monitoring a condition of the process chamber 102. In some embodiments, the processing system may further include a second sensor 114 for monitoring a condition of the abatement system 104. The first and/or the second sensors 112, 114 may be coupled to the process chamber 102 and the abatement system 104, respectively, as shown. In some embodiments, the first sensor 112 may be a plurality of first sensors and the second sensor 114 may be a plurality of second sensors, as shown in FIG. 1. In some embodiments, each first sensor monitors a different condition of the process chamber 102. In some embodiments, each second sensor monitors a different condition of the abatement system 104.

The first and second sensors may include one or more of a pressure transducer, a pneumonic valve, a solenoid valve, mass flow controller, an optical sensor, a temperature sensor, or sensors configured to measure one or more of pH, solid materials, color, density, viscosity, ionic concentration, impurity level, time, conductivity, or volume flowed.

For example, one of the first sensors 112 may be an optical sensor to monitor for the presence of a wafer cassette on a load platform coupled to the process chamber 102 (not shown). If, for example, no wafer cassette is present as determined by the optical sensor, this may be used as at least one indication that the process chamber is currently in an idle state. For example, another of the first sensors 112 may be a mass flow controller, for example disposed between a gas source and the process chamber 102 for providing a measured flow of a process gas into the process chamber 102. If, for example, the mass flow controller is closed, this may be another indication that the process chamber is currently in an idle state. For example, by monitoring one or a combination of first sensors, such as the exemplary optical sensor and mass flow controller, the controller can determine the readiness of the process chamber 102 for operation in an idle mode based on the conditions monitored by the first sensors. Similarly, by monitoring one or a combination of second sensors, the controller can determine the readiness of the abatement system 104 for operation in an idle mode based on the conditions monitored by the second sensors.

In operation, the controller 108 monitors the first and second sensors 112, 114 to determine the readiness of the process chamber and abatement system for operation in an idle mode. Alternatively, the controller 108 may receive state information from another controller (such as a controller of the process chamber or another controller) regarding whether the process chamber and/or the abatement system is operating in an idle or other mode requiring less coolant flow. If the readiness determination indicates that the process chamber 102 or abatement system 104 is ready to operate in an idle mote, or is presently operating in an idle mode, the controller selectively reduces the flow of coolant to the chamber 102 and/or the abatement system 104. For example, if the process chamber 102 is determined to be operating in an idle mode and the abatement system 104 is determined to be operating in an operating mode, the controller 106 selectively reduces the flow of coolant to only the process chamber 102 and not the abatement system 104.

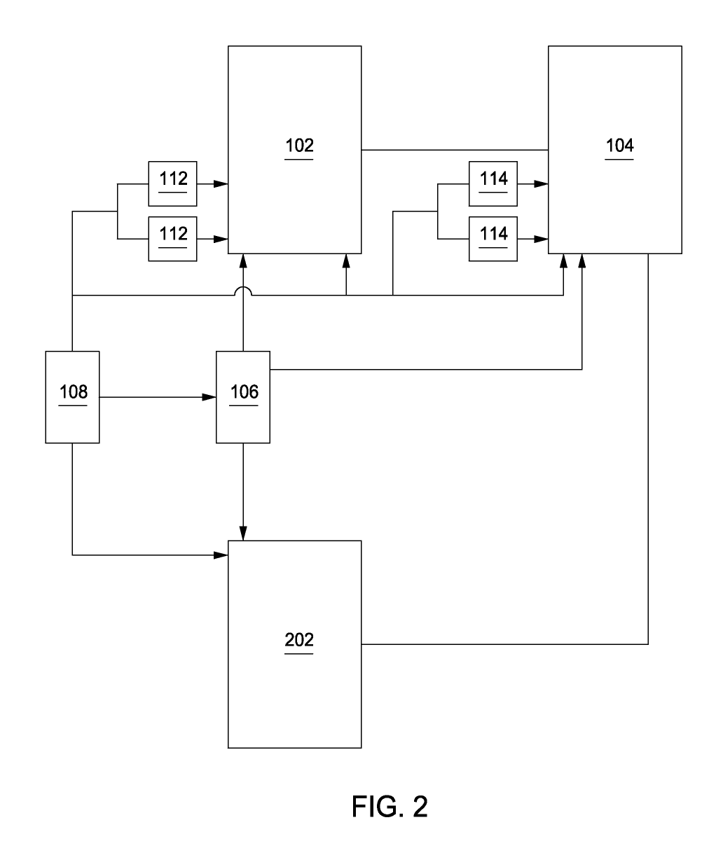

Other configurations of the processing system are possible. For example, in some embodiments, the processing system 100 may further include a second process chamber 202 coupled to the abatement system 104, as illustrated in FIG. 2. The second process chamber 202 may be configured for the same or different processes as the process chamber 102. However, in embodiments where the processes are different in the chamber 102 and the chamber 202, the processes are simultaneously compatible with the abatement system 104 coupled to each chamber 102, 202. Similar to the chamber 102, the coolant source 106 may be further coupled to the second process chamber 202 for providing the coolant to the second process chamber 202. Likewise, the controller 108 may be further configured to determine the readiness of the second process chamber 202 for operation in an idle mode and selectively reducing the flow of the coolant from the coolant source 106 to the second process chamber 202 based on the readiness determination. For example, and similar to the process chamber 102, one or more sensors (not shown) may be coupled to second process chamber 202 for monitoring one or more conditions of the second process chamber 202. The one or more sensors may be monitored by the controller 108 to determine the readiness of the second chamber 202 to operate in an idle mode.

Alternatively, in some embodiments, the processing system may further include a second process chamber 302 and a second abatement system 304 coupled to the second process chamber 302 for receiving effluents, byproducts, and the like therefrom. For example, such a configuration may be utilized when the processes of the process chamber 102 and those of the second process chamber 302 are not compatible with a single abatement system. Similar to the systems described above and illustrated in FIGS. 1-2, the coolant source 106 may be further coupled to the second process chamber 302 and the second abatement system 304 for providing the coolant to the second process chamber 302 and second abatement system 304. Likewise, the controller 108 may be further configured to determine the readiness of the second process chamber 302 and the second abatement system 304 for operation in an idle mode and selectively reduce the flow of the coolant from the coolant source 106 to one or both of the second process chamber 302 or the second abatement system 304 based on the readiness determination. For example, and similar to the process chamber 102 and the abatement system 104, one or more sensors (not shown) may be coupled to second process chamber 202 and the second abatement system 304 for monitoring one or more conditions of the second process chamber 302 and the second abatement system 304. The one or more sensors may be monitored by the controller 108 to determine the readiness of the second chamber 302 and the abatement system 304 to operate in an idle mode.

FIG. 4 depicts a method 400 for selectively reducing the flow of a coolant in a processing system, such as the exemplary processing systems discussed above. In addition, the inventive methods disclosed herein may be utilized with any the processing systems that may operate in a mode having reduced coolant need, such as in an idle mode.

At 402, a process chamber and an abatement system can be monitored, such as process chamber 102 and abatement system 104. For example, one or more conditions of the process chamber and the abatement systems can be monitored. In some embodiments, the one or more conditions can include temperature, pressure, flow rate, pH, color, density, viscosity, ionic concentration, impurity level, time, conductivity, volume flowed, or the like.

As discussed above, the one or more conditions can be monitored by using one or more sensors, such as the first sensor 112 and the second sensor 114 for monitoring the conditions of the process chamber 102 and the abatement system 104, respectively.

At 404, the operating states of the process chamber and the abatement system are determined. For example, the determination of the operating state can be made by monitoring one or more conditions from each of the chamber and the abatement system. For example, and in some embodiments, the determination of the operating state is based on several conditions monitored for each of the process chamber and the abatement system. The monitoring and determination based on multiple conditions can further serve as an added safety feature, such that it remains likely that only a chamber or an abatement system operating in an idle mode has coolant flow selectively reduced. For example, if only one of the many conditions monitored indicates that the chamber or abatement system is in an operating mode, then the flow of coolant will continue at full operating flow.

At 406, the flow of a coolant from a coolant source coupled to the processing system and the abatement system is selectively reduced based on the determined operating states of the process chamber and the abatement system. In some embodiments, the coolant is water. For example, in some embodiments, the flow of the coolant to the process chamber is reduced when the process chamber is in an idle state. In some embodiments, the flow of the coolant to the abatement system is reduced when the abatement system and the process chamber is in an idle state.

In some embodiments, the method 400 can further include monitoring a second process chamber, such as process chamber 202 coupled to the abatement system 104. Similar to the method steps discussed above, an operating state of the second process chamber can be determined, and the flow of coolant from the coolant source coupled to the second processing chamber can be selectively reduced based on the determined operating state of the second processing chamber. Similar to the above, and referring to the processing system depicted in FIG. 2, in some embodiments, the flow of coolant to either or both of the process chamber 102 and second process chamber 104 can be selectively reduced when each chamber is operating in an idle state. In some embodiments, the flow of coolant to the abatement system 104 (as illustrated in FIG. 2) can be reduced when both the process chamber 102 and the second process chamber 202 and the abatement system 104 are operating in idles states.

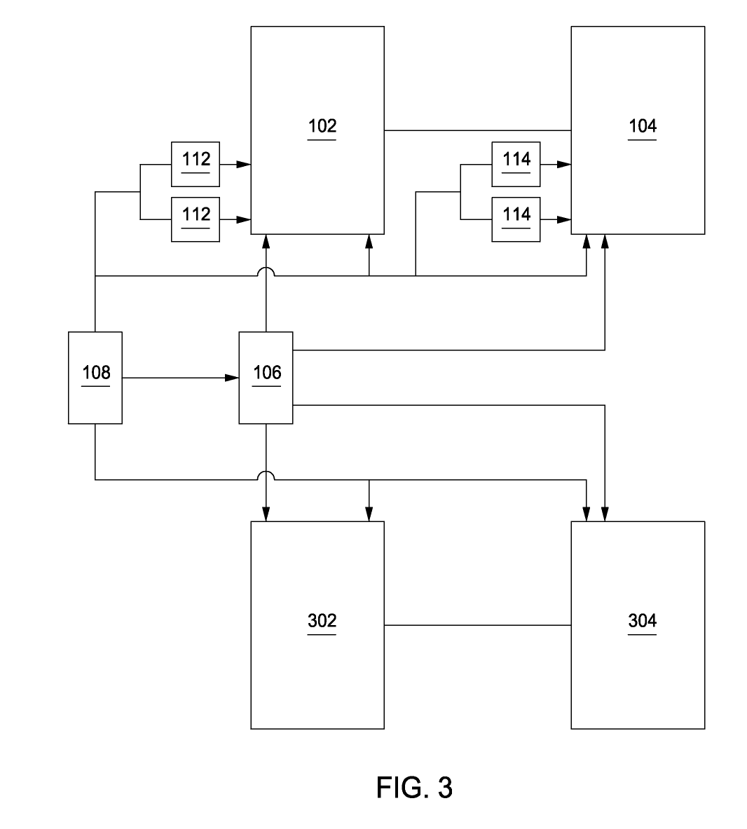

Alternatively, and in accordance with embodiments of a processing system depicted in FIG. 3, the method 400 can further include a second process chamber and second abatement system, such as the second process chamber 302 and the second abatement system 304. In accordance with the embodiments depicted in FIG. 3, each process chamber is coupled to a separate abatement system. Similar to methods discussed above, the conditions of the second process chamber and the second abatement system can be monitored and the operating state of each determined. Once the operating state has been determined, the flow of coolant from the coolant source coupled to the second processing chamber and second abatement system based on the determined operating state of each. In some embodiments, the flow of the coolant to the second process chamber is reduced when the second process chamber is in an idle state. In some embodiments, the flow of the coolant to the second abatement system is reduced when the second process chamber and the second abatement system are in an idle states.

In the embodiments of FIG. 3, unlike those of FIG. 2, the second process chamber 302 and second abatement system 304 are independent from the process chamber 102 and the abatement system 104. Accordingly, the second abatement system 304 can have the flow of coolant selectively reduced when the second abatement system 304 and the second process chamber 302 are operating in idle states, and further while the process chamber 102 and/or abatement system 104 are in full operating states. However, in FIG. 2, where the abatement system 104 is coupled to both the chambers 102, 202, the flow of coolant to the abatement system can be reduced only when both chambers 102, 202 and the abatement system 104 are operating in idle states.

Thus, methods and apparatus for selectively reducing the flow of a coolant are provided herein. The inventive methods and apparatus advantageously reduce consumption of coolant in a processing system by selectively reducing the flow of coolant to one or more components of the processing system, such as a process chamber or abatement system, when each component is operating in an idle state or any other state having reduced coolant need.

While the foregoing is directed to embodiments of the present invention, other and further embodiments of the invention may be devised without departing from the basic scope thereof.

1. A processing system, comprising:
a process chamber;
an abatement system coupled to the process chamber;
a coolant source coupled to the process chamber and the abatement system for providing a coolant to the process chamber and the abatement system; and
a controller configured to determine the readiness of the process chamber and the abatement system for operation in an idle mode and selectively reducing the flow of the coolant from the coolant source to one or both of the process chamber or the abatement system based on the readiness determination.

2. The processing system of claim 1, further comprising:
a first sensor for monitoring a condition of the process chamber; and
a second sensor for monitoring a condition of the abatement system.

3. The processing system of claim 2, wherein the controller determines the readiness of the process chamber and the abatement system for operation in an idle mode based on the condition monitored by the first and second sensors for each of the process chamber and the abatement system.

4. The processing system of claim 2, wherein the first sensor further comprises a plurality of first sensors and the second sensor further comprises a plurality of second sensors.

5. The processing system of claim 4, wherein each first sensor monitors a different condition of the process chamber and wherein each second sensor monitors a different condition of the abatement system.

6. The processing system of claim 1, further comprising:
a second process chamber coupled to the abatement system, wherein the coolant source is further coupled to the second process chamber for providing the coolant to the second process chamber and wherein the controller is further configured to determine the readiness of the second process chamber for operation in an idle mode and selectively reducing the flow of the coolant from the coolant source to the second process chamber based on the readiness determination.

7. The processing system of claim 1, further comprising:
a second processing process chamber; and
a second abatement system coupled to the second processing system, wherein the coolant source is further coupled to the second process chamber and the second abatement system for providing the coolant to the second process chamber and second abatement system, and
wherein the controller is further configured to determine the readiness of the second process chamber and the second abatement system for operation in an idle mode and selectively reducing the flow of the coolant from the coolant source to one or both of the second process chamber or the second abatement system based on the readiness determination.

8. The processing system of claim 1, wherein the coolant source is a non-recirculating coolant source.

9. The processing system of claim 1, wherein the coolant is water.

10. A method for selectively reducing the flow of a coolant in a processing system, comprising:
monitoring a process chamber and an abatement system coupled to the process chamber;
determining operating states of the process chamber and the abatement system; and
selectively reducing the flow of a coolant from a coolant source coupled to the processing system and the abatement system based on the determined operating states of the process chamber and the abatement system.

11. The method of claim 10, wherein the coolant is water.

12. The method of claim 10, wherein the flow of the coolant to the process chamber is reduced when the process chamber is in an idle state.

13. The method of claim 10, wherein the flow of the coolant to the abatement system is reduced when the process chamber and the abatement system are in an idle state.

14. The method of claim 10, wherein monitoring the process chamber and the abatement system further comprises:
monitoring one or more conditions of the process chamber and the abatement systems.

15. The method of claim 14, wherein the one or more conditions include temperature, pressure, flow rate, pH, color, density, viscosity, ionic concentration, impurity level, time, conductivity, or volume flowed.

16. The method of claim 10, further comprising:
monitoring a second process chamber;
determining an operating state of the second process chamber; and
selectively reducing the flow of coolant from the coolant source coupled to the second processing chamber based on the determined operating state of the second processing chamber.

17. The method of claim 16, wherein the second process chamber is coupled to the abatement system and wherein the flow of coolant from the coolant source to the abatement system is selectively reduced based on the determined operating stated of the process chamber, the second process chamber, and the abatement system.

18. The method of claim 16, further comprising:
monitoring a second abatement system;
determining an operating state of the second abatement system; and
selectively reducing the flow of coolant from the coolant source coupled to the second abatement system based on the determined operating state of the second abatement system.

19. The method of claim 18, wherein the second abatement system is coupled to the second process chamber and wherein the flow of coolant from the coolant source to the second abatement system is selectively reduced based on the determined operating stated of the second process chamber and the second abatement system.

20. The method of claim 10, wherein the flow of coolant from the coolant source to both the process chamber and the abatement system is a non-recirculating flow.
